(19) United States
(12) Patent Application Publication
(10) Pub. No.: US 2002/0059232 A1
(43) Pub. Date: May 16, 2002

(54) Apparatus and process for statistical examination of large databases

(76) Inventors: Peter Grant, Melbourne (AU); Gary C. Morgan, Melbourne (AU)

Correspondence Address: Max Stul Oppenheimer, P.O. Box 50, Stevenson, MD, 21153, US

(21) Appl. No.: 09/833,200

(22) Filed: Apr. 11, 2001

Related U.S. Application Data
(60) Provisional application No. 60/196,362, filed on Apr. 12, 2000.

(51) Int. Cl. G06F 7/00

(52) U.S. Cl. 707/7

(57) ABSTRACT

A method for processing survey information in a relational database, comprises the steps of providing a relational database of survey data, comprising data and a set of logical relationships between said data, extracting relevant data from said relational database, restructuring the extracted relevant data by inverting the data progressively as it is delivered from the relational database, and selecting data from the restructured database.

Priority Claim

This application is entitled to and claims the benefit of U.S. Provisional Patent Application No. 60/196,362 filed Apr. 12, 2000, the contents of which are incorporated herein by reference.

The attached document, entitled “Oct. 5, 1999 Memorandum from Peter Grant to Gary Morgan and Michele Levine Re: Development Project ‘FIREBIRD’”, authored by Peter Grant is also incorporated herein by reference.

### FIELD AND BACKGROUND OF THE INVENTION

1. Field of the Invention

The present invention relates in general to database management, and more particularly to methods for extracting data from large databases.

### SUMMARY OF THE INVENTION

The invention is summarized in the attached memorandum.

### DESCRIPTION OF THE PREFERRED EMBODIMENT

The currently envisioned preferred embodiment is set forth in the attached memorandum.

What is claimed is:

1. A method for processing survey information in a relational database, comprising the steps of:
providing a relational database of survey data, comprising data and a set of logical relationships between said data,
extracting relevant data from said relational database,
restructuring the extracted relevant data by inverting the data progressively as it is delivered from the relational database, and
selecting data from the restructured database.
